(19) United States
(12) Patent Application Publication
(10) Pub. No.: US 2010/0328956 A1
(43) Pub. Date: Dec. 30, 2010

(54) LED LAMP

(75) Inventor: WEN-XIANG ZHANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/542,727

(22) Filed: Aug. 18, 2009

(30) Foreign Application Priority Data
Jun. 25, 2009 (CN) 200910303685.6

(51) Int. Cl. F21V 29/00

(52) U.S. Cl. 362/294; 362/373

(57) ABSTRACT

An LED lamp includes a heat sink, an LED module, a lamp cover, a driving circuit module and a rear cover. The heat sink defines isolated first and second cavities in two opposite ends thereof. The LED module is received in the first cavity of the heat sink and connecting with the heat sink. The lamp cover is arranged at an opening of the first cavity and covering the LED module. The driving circuit module is received in the second cavity of the heat sink and electrically connecting with the LED module. The rear cover is arranged at an opening of the second cavity of the heat sink and covering the driving circuit module.

### BACKGROUND

1. Technical Field

The present disclosure relates to light emitting diode (LED) lamps, and particularly to an LED lamp with a simple structure and having high heat dissipating efficiency.

2. Description of Related Art

The technology of LED has been rapidly developed in recent years from indicators to illumination applications. LEDs are widely used in many fields due to their excellent properties, including environment friendliness, low power consumption, long-term reliability, and et al.

Generally, an LED lamp includes a plurality of LEDs, a driving circuit module for activating the LEDs and controlling the brightness and color blending of the LED lamp, and a heat sink for dissipating heat generated by the LEDs. In order to assembly the components of the LED lamp together, the LED lamp is designed to a complex structure. Further, an additional receiving member is provided to receive the driving circuit module, to thereby make sure of the electrical safety of the LED lamp, especially when the LED lamp is used in an outdoor environment. Thus, the structure of the LED lamp is complex. The assembly and maintenance of the LED lamp is inconvenient.

For the foregoing reasons, therefore, there is a need in the art for an LED lamp which overcomes the limitations described.

### BRIEF DESCRIPTION OF THE DRAWINGS

Many aspects of the present embodiment can be better understood with reference to the following drawings. The components in the drawings are not necessarily drawn to scale, the emphasis instead being placed upon clearly illustrating the principles of the present embodiment. Moreover, in the drawings, like reference numerals designate corresponding parts throughout the several views.

FIG. 1 is an assembled, isometric view of an LED lamp in accordance with an exemplary embodiment.

FIG. 2 is an exploded, isometric view of the LED lamp of FIG. 1.

FIG. 3 is an inverted view of the LED lamp of FIG. 1.

FIG. 4 is an exploded, isometric view of the LED lamp of FIG. 3.

### DETAILED DESCRIPTION

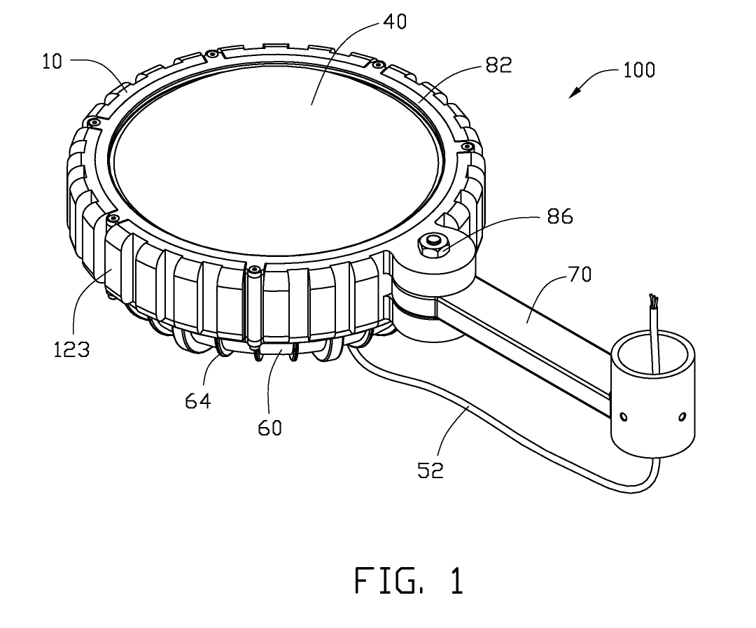

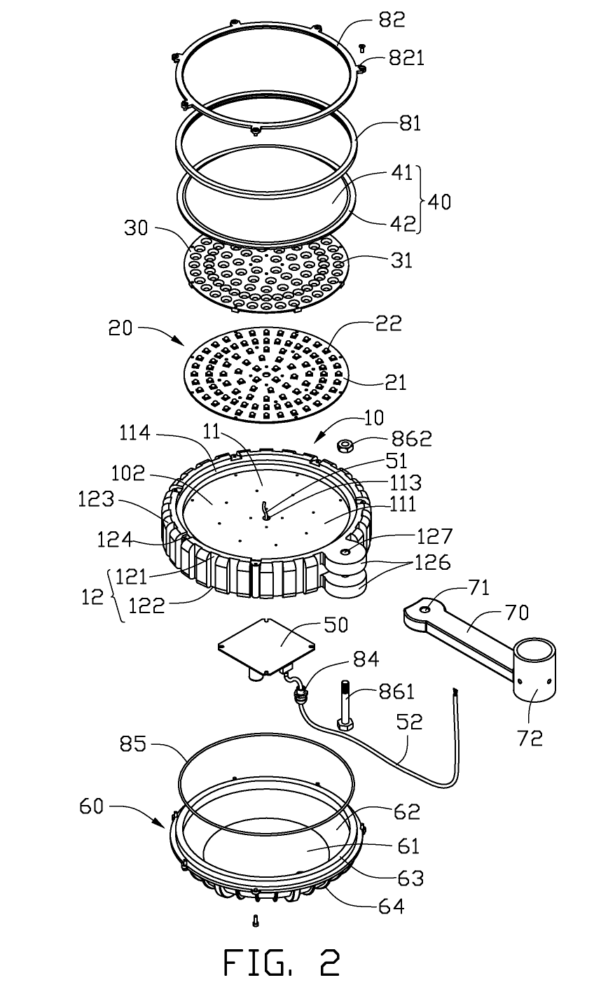

Referring to FIGS. 1 and 2, an LED lamp 100 according to an exemplary embodiment includes a heat sink 10, an LED module 20, a reflecting plate 30, a lamp cover 40, a driving circuit module 50, a rear cover 60 and a connecting member 70. The LED module 20, the reflecting plate 30 and the lamp cover 40 are arranged at a front end of the heat sink 10, while the driving circuit module 50 and the rear cover 60 are arranged at a rear end of the heat sink 10. The connecting member 70 is connected to a peripheral edge of the heat sink 10.

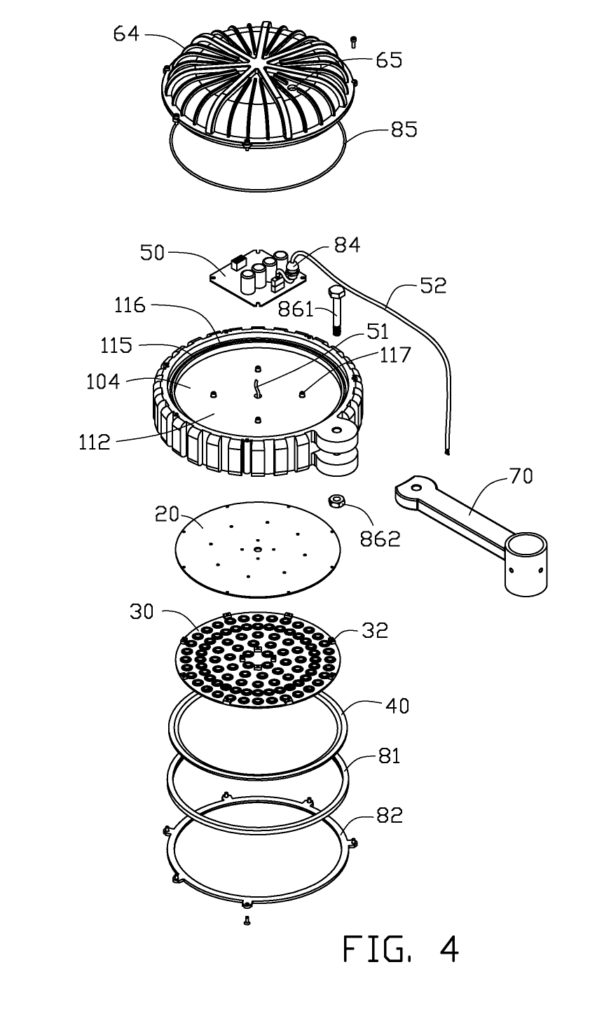

The heat sink 10 is substantially a flat cylinder. In other words, the heat sink 10 has a diameter greater than a height thereof. The heat sink 10 is made of metal having a high thermal conductivity, such as copper or aluminum. Referring also to FIG. 4, the heat sink 10 defines first and second cavities 102, 104 at the front end and the rear end, respectively. The heat sink 10 includes a circular base 11 isolating the first cavity 102 from the second cavity 104, and an annular heat dissipating portion 12 surrounding the base 11. The base 11 has a front surface 111 facing the lamp cover 40 and a rear surface 112 (best seen in FIG. 4) facing the rear cover 60. The LED module 20 and the driving circuit module 50 are respectively received in the first and the second cavities 102, 104 of the heat sink 10 and mounted to the base 11 of the heat sink 10. The heat sink 10 is used for dissipating heat generating by the LED module 20 to the ambient atmosphere. The base 11 defines axially a through hole 113 in a center thereof. The through hole 113 communicates the first cavity 102 with the second cavity 104, and is utilized for an electrical wire 51 extending therethrough to electrically connect the LED module 20 with the driving circuit module 50.

The heat dissipating portion 12 includes an annular front sidewall 121 and an annular rear sidewall 122. The front and the rear sidewalls 121, 122 extend forwardly and backwardly from a peripheral edge of the base 11, respectively. An inner surface of the front sidewall 121 and the front surface 111 of the base 11 cooperatively define the first cavity 102 with an opening thereof facing the lamp cover 40, while an inner surface of the rear sidewall 122 and the rear surface 112 of the base 11 cooperatively define the second cavity 104 with an opening thereof facing the rear cover 60. A plurality of spaced heat dissipating ribs 123 are radially formed on an outer circumferential surface of the heat dissipating portion 12. The heat dissipating ribs 123 extend axially. In the first cavity 102, an annular first step 114 protrudes frontward from the front surface 111 of the base 11 and is located adjacent to the inner surface of the front sidewall 121 of the heat dissipating portion 12. The first step 114 is formed to support the lamp cover 40 thereon when mounting the lamp cover 40 to the heat sink 10. In the second cavity 104, an annular second step 115 (best seen in FIG. 4) protrudes rearward from the rear surface 112 of the base 11 and is located adjacent to the inner surface of the rear sidewall 122 of the heat dissipating portion 12. The second step 115 is formed to support the rear cover 60 thereon when mounting the rear cover 60 to the heat sink 10. The second step 115 defines an annular groove 116 therein. The groove 116 is provided for receiving a sealing ring 85 therein.

The LED module 20 and the reflecting plate 30 are received in the first cavity 102 of the heat sink 1 0. The LED module 20 is mounted on the front surface 111 of the base 11, and includes a circular printed circuit board 21 and a plurality of spaced LEDs 22 evenly mounted on a front surface of the printed circuit board 21. A rear surface of the printed circuit board 21 thermally contacts with the front surface 111 of the base 11 to transfer heat generated by the LEDs 22 to the base 11 of the heat sink 10. Then the heat is transferred to the heat dissipating portion 12 of the heat sink 10 and dissipated to ambient atmosphere particularly by the heat dissipating ribs 123.

The reflecting plate 30 is circular and has a size which is the same as that of the printed circuit board 21 of the LED module 20. The reflecting plate 30 is arranged on the LED module 20, and defines a plurality of through holes 31 therein corresponding to the LEDs 22 of the LED module 20. The LEDs 22 of the LED module 20 are received in the through holes 31 of the reflecting plate 30. Light emitted by the LEDs 22 of the LED module 20 is reflected by annular surfaces of the reflecting plate 30 which define the through holes 31 thereof. A plurality of screws (not shown) successively extend through the reflecting plate 30 and the printed circuit board 21 of the LED module 20, and then engage with the base 11 of the heat sink 10 to mount the reflecting plate 30 and the LED module 20 to the base 11. Outer diameters of the reflecting plate 30 and the printed circuit board 21 of the LED module 20 are smaller than an inner diameter of the first step 114. Thus, the reflecting plate 30 and LED module 20 are enclosed by the first step 114. The reflecting plate 30 forms a plurality of supporting blocks 32 (FIG. 4) on a rear surface thereof. The supporting blocks 32 abut the LED module 20 to support the reflecting plate 30 thereon.

The lamp cover 40 is arranged at the opening of the first cavity 102 of the heat sink 10 and covers the LED module 20 and the reflecting plate 30. The lamp cover 40 is made of transparent glass or plastic. The lamp cover 40 includes a convex transparent portion 41 and an annular mounting portion 42 at a peripheral of the transparent portion 41. The mounting portion 42 of the lamp cover 40 is enclosed by an annular cushion 81. The cushion 81 is annular, and has a U-shaped cross-section. An annular groove (not labeled) is defined in an internal side of the cushion 81. The mounting portion 42 of the lamp cover 40 is inserted into the groove of the cushion 81. The mounting portion 42 of the lamp cover 40 and the cushion 81 are placed on the first step 114, and mounted to the first step 114 of the heat sink 10 via an annular fixing member 82 arranged on the cushion 81. The fixing member 82 forms a plurality of ears 821 at an outer circumferential surface thereof. The front sidewall 121 of the heat sink 10 defines a plurality of grooves 124 corresponding to the ears 821 of the fixing member 82 for receiving the ears 821 of the fixing member 82 therein. A plurality of screws (not labeled) extend through the ears 821 of the fixing member 82 and engage with the front sidewall 121 of the heat sink 10 to mount the fixing member 82 on the heat sink 10. The mounting portion 42 of the lamp cover 40 is securely and hermetically mounted on the first step 114 of the heat sink 10 by a pressing of the fixing member 82 on the cushion 81 and the mounting portion 42. The lamp cover 40 seals the first cavity 102 of the heat sink 10 to prevent dust and water from entering into the first cavity 102.

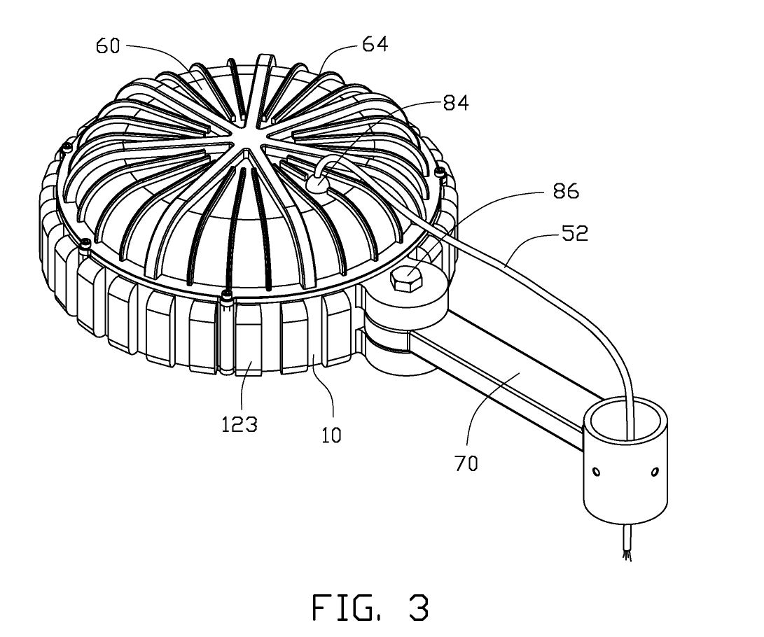

Referring also to FIGS. 3 and 4, the driving circuit module 50 is received in the second cavity 104 of the heat sink 10, and utilized for activating the LED module 20 and controlling the brightness and color mixture of the LED lamp 100. The driving circuit module 50 electrically connects with the LED module 20 via the electrical wire 51, and electrically connects with an external power source via a power wire 52. A plurality of posts 117 are formed on the rear surface 112 of the base 11 of the heat sink 10 to mount the driving circuit module 50 thereon.

The rear cover 60 is arranged at the opening of the second cavity 104 of the heat sink 10 and covers the driving circuit module 50 to protect the driving circuit module 50. The rear cover 60 is made of a metal having a high thermal conductivity, such as copper or aluminum, and thermally contacts with the heat sink 10. The rear cover 60 is dish-shaped. The rear cover 60 includes a circular rear plate 61 and an annular wall 62 extending outwardly and forwardly from a peripheral edge of the rear plate 61 towards the heat sink 10. The annular wall 62 of the rear cover 60 forms an annular flange 63 at a front end thereof facing the heat sink 10. A plurality of heat dissipating ribs 64 are radially formed on an outer surface of the rear cover 60. The heat dissipating ribs 64 extend rearwards from a front end of the annular wall 62 towards a center of the rear cover 60. The rear cover 60 defines a through hole 65 therein for the power wire 52 extending therethrough. A waterproof plug 84 is disposed around the power wire 52 and inserted in the through hole 65 of the rear cover 60 to seal the through hole 65. When the rear cover 60 is mounted to the heat sink 10, the annular flange 63 of the rear cover 60 is placed on the second step 115 of the heat sink 10. A plurality of screws (not labeled) extend a periphery edge of the rear cover 60 and engage with the rear sidewall 122 of the heat sink 10 to mount the rear cover 60 to the heat sink 10. When the heat generated by the LEDs 22 is transferred to the base 11 of the heat sink 10, one portion of the heat is directly dissipated to ambient atmosphere via the heat sink 10, other portion of the heat is transferred from the heat sink 10 to the rear cover 60 and then dissipated to ambient atmosphere via the rear cover 60.

Referring back to FIGS. 1 and 2, the connecting member 70 is an elongated pole. The connecting member 70 defines a mounting hole 71 at an inner end thereof adjacent to the heat sink 10 and forms a sleeve 72 at an outer end thereof away from the heat sink 10. The heat dissipating portion 12 of the heat sink 10 forms a pair of ears 126 on the outer circumferential surface thereof. The pair of ears 126 are spaced from each along the axial direction of the heat sink 10. Each ear 126 defines axially a fixing hole 127 therein corresponding to the mounting hole 71 of the connecting member 70. The inner end of the connecting member 70 is sandwiched between the pair of ears 126 and connects with the pair of ears 126 via a securing member 86. The securing member 86 includes a screw bolt 861 extending through the fixing holes 127 of the pair of the ears 126 and the mounting hole 71 of the connecting member 70, and a screw nut 862 engaged with the screw bolt 861. The sleeve 72 of the connecting member 70 is used for mounting the LED lamp 100 to a fixing device. For example, when the LED lamp 100 is used as an accessorial lamp for a street lamp, the LED lamp 100 can be mounted to a lamp pole of the street lamp via the connecting member 70. A position of the LED lamp 100 can be easily adjusted by releasing the screw nut 862 of the securing member 86, horizontally rotating the LED lamp 100 relative to the connecting member 70 to a desired position and finally fastening the screw nut 862.

In the LED lamp 100, the heat sink 10 defines the first and the second cavities 102, 104 in two opposite ends thereof to respectively receive the LED module 20 and the driving circuit module 50 therein, which simplifies the structure of the LED lamp 100. Thus, assembly and maintenance of the LED lamp 100 is convenient. Furthermore, the LED lamp 100 has a compact structure which is very helpful in transportation and inventory.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An LED lamp, comprising:
a heat sink defining first and second cavities in two opposite ends thereof;
an LED module received in the first cavity of the heat sink and connecting with the heat sink;
a lamp cover arranged at an opening of the first cavity and covering the LED module;
a driving circuit module received in the second cavity of the heat sink and electrically connecting with the LED module; and
a rear cover arranged at an opening of the second cavity of the heat sink and covering the driving circuit module.

2. The LED lamp of claim 1, wherein the heat sink comprises a base isolating the first cavity from the second cavity, a peripheral edge of the base extending forwardly and backwardly to form the first and the second cavities at the front and rear sides of the base, respectively.

3. The LED lamp of claim 2, wherein the heat sink is substantially a flat cylinder.

4. The LED lamp of claim 2, wherein the base of the heat sink defines a through hole therein, an electrical wire extending through the through hole of the base to electrically connect the LED module with the driving circuit module.

5. The LED lamp of claim 1, further comprising a reflecting plate received in the first cavity of the heat sink and located in front of the LED module, the LED module comprising a printed circuit board and a plurality of LEDs mounted on the printed circuit board, the printed circuit board of the LED module being thermally contacted with the base of the heat sink, the reflecting plate defining a plurality of through holes corresponding to the LEDs of the LED module, the LEDs of the LED module being received in the through holes of the reflecting plate.

6. The LED lamp of claim 1, wherein the rear cover defines a through hole therein for a power wire extending therethrough to electrically connect with the driving circuit module, a waterproof plug being disposed around the power wire and sealing the through hole of the rear cover.

7. The LED lamp of claim 1, wherein the heat sink comprises a base isolating the first cavity from the second cavity, and an annular heat dissipating portion surrounding the base, a plurality of spaced heat dissipating ribs being radially formed on an outer peripheral surface of the heat dissipating portion.

8. The LED lamp of claim 7, wherein the heat dissipating ribs of the heat sink extend axially front the first cavity to the second cavity.

9. The LED lamp of claim 7, wherein the rear cover is made of metal and thermally contacts with the heat sink to dissipate heat transferred from the heat sink.

10. The LED lamp of claim 9, wherein the rear cover comprises a rear plate and an annular wall extending outwardly and forwardly from a peripheral edge of the rear plate towards the heat sink, a plurality of heat dissipating ribs being raidally formed on an outer surface of the rear cover.

11. The LED lamp of claim 10, wherein the heat dissipating ribs of the rear cover extend rearwards from a front end of the annular wall towards a center of the rear cover.

12. The LED lamp of claim 7, further comprising a connecting member connected to an outer peripheral edge of heat dissipating portion for fixing the LED lamp.

13. The LED lamp of claim 12, wherein the heat dissipating portion of the heat sink forms a pair of ears on the outer peripheral surface thereof, an inner end of the connecting member is connected to the pair of ears.

14. The LED lamp of claim 12, wherein the connecting member is an elongated pole and forms a sleeve at an outer end thereof.

15. The LED lamp of claim 1, wherein the lamp cover is made of one of transparent glass and transparent plastic.
